(19) United States
(12) Patent Application Publication
(10) Pub. No.: US 2023/0267174 A1
(43) Pub. Date: Aug. 24, 2023

(54) INFORMATION PROCESSING DEVICE AND INFORMATION PROCESSING METHOD

(71) Applicant: NEC Corporation, Minato-ku, Tokyo (JP)

(72) Inventor: Motoi SUZUKI, Tokyo (JP)

(73) Assignee: NEC Corporation, Minato-ku, Tokyo (JP)

(21) Appl. No.: 18/014,389

(22) PCT Filed: Jul. 7, 2020
(86) PCT No.: PCT/JP2020/026559

§ 371 Date: Jan. 4, 2023

(51) Int. Cl. G06F 17/18

(52) U.S. Cl. CPC G06F 17/18

(57) ABSTRACT

In order to satisfy both of convergence of a dynamical system and high parallelization efficiency when obtaining samples that follow a probability distribution, the information processing device 10 includes a processing unit 20 having a difference calculator 11 which calculates differences between evaluation functions in parallel when changing a state of each of variables selected from a plurality of variables, and a difference modification unit 12 which modifies the difference calculated by the difference calculator 11 so as to cancel an error between a sequentially calculated difference.

### TECHNICAL FIELD

This invention relates to an information processing device and an information processing method for controlling sampling to obtain samples that follow a probability distribution in a predetermined space.

### BACKGROUND ART

One statistical mechanical model of a magnetic material is an Ising model which is formulated by a Hamiltonian given by a binary variable and its quadratic form. The Ising model describes a spin behavior of a magnetic material. The Ising model can be applied as an evaluation function for many combinatorial optimization problems. For example, optimization problems can be solved universally by applying a simulated annealing to the Ising model.

For example, patent literature 1 describes an approach to universally solving a combinatorial optimization problem using the Ising model. In addition, non-patent literature 1 describes a specific method for formulating many kinds of combinatorial optimization problems, including a number partitioning problem, a graph partitioning problem, a satisfiability problem, a traveling salesman problem etc., into the Ising model or an equivalent model.

The probability distribution of the Ising model at a given temperature T can be calculated by a Markov Chain Monte Carlo method (MCMC). In the Markov Chain Monte Carlo method, one spin is selected and the variation of the Hamiltonian when changing the spin state is calculated. In addition, the spin state is sampled by a dynamical system that accepts or rejects a state update according to a probability following a Boltzmann weight corresponding to the temperature, with a probability distribution according to the temperature T and the Hamiltonian.

Hereinafter, a case in which a primitive (general) Markov Chain Monte Carlo method is applied to an Ising model is explained as an example. First, notations and terminologies are explained.

In statistical mechanics, the function H(x) is called the Hamiltonian or the energy function. The state in which the Hamiltonian is minimized is called the ground state.

$$H \left(x\right) = {\sum }_{i j} {J}_{i j} {x}_{i} {x}_{j} \qquad \text{(1)}$$

In equation (1), xᵢ is the i-th variable. In the Ising model, the value of xᵢ is either +1 or -1. In statistical mechanics, each variable is called a spin. x is a label consisting of all N variables. jᵢⱼ is a constant that represents binding connecting the i-th variable and the j-th variable.

In the field of optimization, the Hamiltonian is called an evaluation function or a cost function. The ground state expressed in equation (2) is called the optimal solution. The Hamiltonian for many optimization problems is shown in non-patent literature 1. For example, Jᵢⱼ is obtained by the method shown in non-patent literature 1. Then, the optimal solution is obtained as shown in equation (2).

$${x}_{m} = {min}_{x} H \left(x\right) \qquad \text{(2)}$$

The objective of the Markov Chain Monte Carlo method is to sample the state x according to the probability distribution (Boltzmann distribution) expressed in equation (3) for temperature T.

$$exp \left(- \frac{H \left(x\right)}{T}\right) \qquad \text{(3)}$$

The sampling operation includes following six processes.

Process 1. determining the initial state x at random.

Process 2. randomly selecting one of the N variables.

Process 3. setting the state in which the selected variable is multiplied by -1 (flip), and calculating the difference Δ (refer to equation (4)). Flip means an operation of making the variable -1 if it is 1 or a converse operation.

$$\text{Δ} = \text{H} \left({\text{x}}^{′}\right) \text{- H} \left(\text{x}\right) \qquad \text{(4)}$$

Process 4. flipping the variable with probability expressed by equation (5) below.

$$min \left(exp \left(- \frac{\text{Δ}}{T}\right) ,\right) \qquad \text{(5)}$$

Process 5. updating the state (x′ to x) when accepted, otherwise (in case of reject) not updating the state.

Process 6. repeating Processes 2 to 4.

During the above operation, in the extreme limit of an infinite number of iterations, the probability of occurrence of state x is guaranteed to converge to the desired probability distribution.

Processes 1-5 are one implementation of the Markov Chain Monte Carlo method. The choices of the probability distribution for selecting the next state from the current state (corresponding to Processes 2-3; this probability distribution is called the proposal distribution), and of the probability for accepting the update that appears in Process 4 are arbitrary.

However, in order for the probability distribution at the convergence destination to match the desired probability distribution, the proposal distribution and the acceptance probability need to be chosen to satisfy two conditions which are the balance condition and the ergodicity. In general, it is not easy to construct a dynamical system that satisfies these two conditions. As well-known methods, the Metropolis method (corresponding to Processes 2-4 above) or the heat bath method are employed.

When the Markov Chain Monte Carlo method is used, the processing time increases as the size of the target model increases. Therefore, a solution method using the Markov Chain Monte Carlo method requires a device to reduce the processing time. In some cases, the processing of a dynamical system for a large-scale model is executed using a large-scale computer. Even when a large-scale computer is used, it is important to parallelize the process with high efficiency for reducing the processing time.

There are patent literature 2, patent literature 3, and non-patent literature 2 as references describing a technique for parallelizing a state update of a dynamical system. The technique described in patent literature 2 selects multiple variables in the part corresponding to Process 2 above and performs Processes 3-4 independently for each variable. The technique selects one of the accepted variables in Process 4 and updates the state of only that variable. Although Processes 3-4 are executed multiple times in a single iteration, they can be parallelized because they are independent.

Compared to the primitive process described above, the technique described in patent literature 2 improves an efficiency of solution search in the optimization problem because the state is updated more frequently in a single iteration. However, in patent literature 2, the dynamical system does not satisfy the balance condition. Therefore, the probability distribution of the convergence destination is unknown. In the technique described in patent literature 2, the difference calculation (Process 3), which is a bottleneck in the general Ising model, is executed for the parallel number. However, only one is accepted at most. The results of other calculations are not used for state updating.

The technique described in patent literature 3 uses real values instead of discrete values for variables and performs state updating based on Hamiltonian dynamics. Hamiltonian dynamics is a deterministic dynamical system that follows a differential equation, unlike the Markov Chain Monte Carlo method. The technique can, in principle, update each variable in parallel. However, the convergence destination of the probability distribution of the state due to sampling based on this dynamical system is unknown. Further, the convergence of the probability distribution is also unknown. Therefore, there is concern about universal use of the solution method when applied to the combinatorial optimization problem.

The technique described in non-patent document 2 selects multiple variables in Process 2, and performs Processes 3-4 independently for each variable, as is the case with the technique described in patent document 2. Each parallelized process is given an ordinal label. The state is updated only for the variable with the smallest label among variables accepted in Process 4, and not for the other variables. In other words, in the technique described in non-patent document 2, as in the technique described in patent document 2, although the difference calculation (Process 3) is executed in parallel, the processing results are rejected except for the processing result concerning at most one variable that is finally accepted. The processing described in patent literature 2 can be thought of as a speculative method that attempts to update the states of multiple variables, accepts the one that succeeds, and rejects the others.

### CITATION LIST

### Patent Literature

PTL 1: International Publication No. 2019/078354
PTL 2: Japanese Patent Laid-Open No. 2018-41351
PTL 3: Japanese Patent Laid-Open No. 2019-145010

### Non Patent Literature

NPL 1: A. Lucas, “Ising formulations of many NP problems”, Frontiers in Physics, 2014, Volume 2, Article 5
NPL 2: J. Knopman and J.S. Aude, “Parallel simulated annealing: an adaptive approach”, Proceedings 11th International Parallel Processing Symposium, Geneva, Switzerland, 1997, pp. 522-526

### SUMMARY OF INVENTION

### Technical Problem

When parallelizing the Markov Chain Monte Carlo method, the convergence to the target probability distribution is violated when using the method as described in patent literature 2 and patent literature 3. In addition, high parallelization efficiency cannot be obtained.

In patent literature 2 and patent literature 3, parallelization is achieved by changing the shape of the target probability distribution and making a method for the optimization problem into a specialized method. As mentioned above, those methods do not guarantee the convergence destination and the convergence of the dynamical system. Therefore, those methods are not sufficient as a sampling method to converge to the target probability distribution.

The techniques described in patent literature 2 and non-patent literature 2 can also perform multiple difference calculations in parallel. However, results other than at most one variable that is finally accepted are rejected, and this also prevents high parallelization efficiency.

The purpose of the present invention is to provide a method for processing sampling that solves the problem of incompatibility between convergence of a dynamical system and high parallelization efficiency when obtaining samples that follow a probability distribution.

### Solution to Problem

The information processing device according to the present invention includes processing means including difference calculation means for calculating differences between evaluation functions in parallel when changing a state of each of variables selected from a plurality of variables, and difference modification means for modifying the difference calculated by the difference calculation means so as to cancel an error between a sequentially calculated difference.

The information processing method according to the present invention includes calculating differences between evaluation functions in parallel when changing a state of each of variables selected from a plurality of variables, and modifying the calculated difference so as to cancel an error between a sequentially calculated difference.

The information processing program according to the invention causes a computer to execute a process of calculating differences between evaluation functions in parallel when changing a state of each of variables selected from a plurality of variables, and a process of modifying the calculated difference so as to cancel an error between a sequentially calculated difference.

### Advantageous Effects of Invention

According to the present invention, when obtaining samples that follow a probability distribution, it is possible to satisfy both of convergence of a dynamical system and high parallelization efficiency.

### BRIEF DESCRIPTION OF DRAWINGS

FIG. 1 It depicts a block diagram showing a configuration example of the information processing device of the first example embodiment.

FIG. 2 It depicts a flowchart showing an operation of the information processing device of the first example embodiment.

FIG. 3 It depicts a block diagram showing a configuration example of the information processing device of the second example embodiment.

FIG. 4 It depicts a block diagram showing a configuration example of the processing device in the information processing device of the second example embodiment.

FIG. 5 It depicts a flowchart showing an operation of the processing device in the second example embodiment.

FIG. 6 It depicts an explanatory diagram showing a calculation flow of MCMC by a general information processing device.

FIG. 7 It depicts an explanatory diagram showing a calculation flow of MCMC by the information processing device of the second example embodiment.

FIG. 8 It depicts a block diagram showing an example of a computer with a CPU.

FIG. 9 It depicts a block diagram showing the main part of the information processing device.

FIG. 10 It depicts a block diagram showing the main part of another type of the information processing device.

### DESCRIPTION OF EMBODIMENTS

Hereinafter, example embodiments of the present invention will be described with reference to the drawings.

### Example Embodiment 1

### Description of Configuration

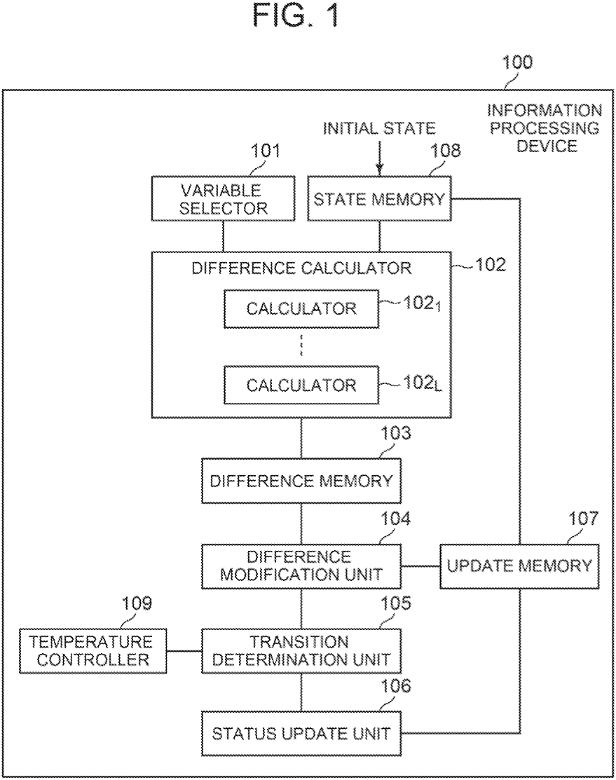

FIG. 1 is a block diagram showing a configuration example of the information processing device of the first example embodiment (example embodiment 1). The information processing device 100 of the first example embodiment comprises a variable selector 101, a difference calculator 102, a difference memory 103, a difference modification unit 104, a transition determination unit 105, a state update unit 106, an update memory 107, a state memory 108, and a temperature controller 109. The difference calculator 102 has L calculators 102₁ - 102_{L} that can operate in parallel. L is a constant that specifies the parallel number. L is set in advance based on the computing capacity of the information processing unit 100 and other factors.

Hereinafter, the case where an Ising model consisting of N variables taking +1 or -1, and a constant L between 2 and N specifying the parallel number are used will be taken as an example. While one variable is selected in Process 2 above, in this example embodiment, L variables are selected. In the following, the case where the dynamic system for state update is the Markov Chain Monte Carlo method will be described as an example.

The variable selector 101 selects L variables to be updated out of N variables. The difference calculator 102 (specifically, each of the L calculators 102₁ to 102_{L}) independently calculates, for each of the L variables selected by the variable selector 101, a difference between evaluation functions before and after the variable is multiplied by -1. The difference calculator 102 stores the calculation result in the difference memory 103.

The difference memory 103 stores each difference calculated by the difference calculator 102. The difference modification unit 104 calculates modification (modification value) of difference based on differences stored in the difference memory 103 and a set of variables updated by the state update unit 106, that is stored in the update memory 107.

The transition determination unit 105 calculates a transition probability according to the difference calculated by the difference modification unit 104 and a value of temperature controlled by the temperature controller 109. The transition determination unit 105 determines whether to accept or reject a state update according to the transition probability.

The state update unit 106 updates the state of the state memory 108 based on determination of the transition determination unit 105. The state update unit 106 stores the updated variable in the update memory 107. The update memory 107 stores the updated variable.

The state memory 108 stores current states of all variables. The temperature controller 109 controls temperature as a control parameter for applying the simulated annealing.

### Description of Operation

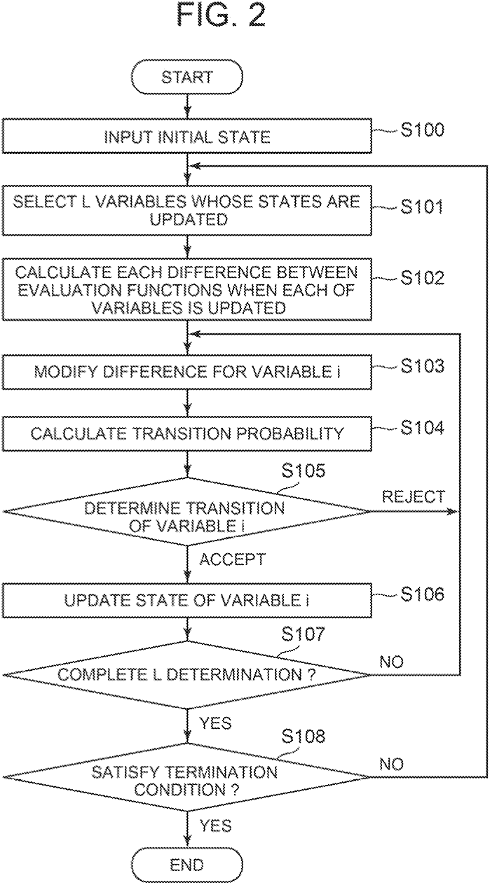

Next, the operation of this example embodiment is explained with reference to the flowchart of FIG. 2.

Once the initial state is determined, the initial state is stored in the state memory 108 (step S100). The initial state is selected randomly.

In this example embodiment, the number of iterations is M, and the following processing of steps S101 to S106 is repeated M times.

First, in step S101, the variable selector 101 selects L variables whose states are updated. Next, in step S102, the difference calculator 102 (specifically, each of L calculators 102₁ to 102_{L}) calculates a difference between evaluation functions when each of the variables selected in step S101 is multiplied by -1 in parallel. The difference calculator 102 stores the calculation results in the difference memory 103. The evaluation function is expressed, for example, as in equation (6). The difference between evaluation functions is expressed by equation (7).

$$f : S \to ℝ \qquad \text{(6)}$$

S is a set consisting of all possible states that all variables can take.

For example, S is expressed as follows.

$$f \left(x\right) = {\sum }_{i j} {J}_{i j} {x}_{i} {x}_{j}$$

xᵢ is a spin variable {+1, -1}. jᵢⱼ is a real number representing binding between spins i and j.

$$Δ {f}_{i} \left(x\right) = f \left({{x}^{′}}_{i}\right) - f \left(x\right) \qquad \text{(7)}$$

xᵢ′ indicates the state in which the i-th variable in state x ∈ S has been updated.

Next, processing of steps S103 to S106 is executed in turn for each of L variables (represented by variable i) selected in the process of step S101. Although the processing of steps S103 to S106 is different from the processing of the above-mentioned primitive MCMC, it reproduces the same dynamical system.

In step S103, the difference modification unit 104 calculates modification of difference (refer to equation (8)) for variable i, using the value of the difference between evaluation functions of variable i stored in the difference memory 103 and a set of variables j (1 ≤ j ≤ N), whose variable states have been updated up to that point, stored in the update memory 107. This modification restores the value of the difference to that used in the primitive dynamical system by the non-parallel process, and the dynamical system of the state update is consistent with the difference by the primitive Markov Chain Monte Carlo method.

$${\text{Δ}}^{′} {\text{f}}_{\text{i}} \left(\text{x} \left({\text{t}}^{′}\right) \text{, x} \left(\text{t}\right)\right) \qquad \text{(8)}$$

x(t′) indicates the current state. x(t) is the state in which the difference is calculated in the process of the step S102. Then, it is constructed to satisfy Δfᵢ(x (t′)) = Δfᵢ(x (t) + Δ′fᵢ(x (t′), x (t)) .

Next, in step S104, the transition determination unit 105 calculates a transition probability (refer to equation (9)) according to the difference calculated by the difference modification unit 104 and a value of temperature controlled by the temperature controller 109. In step S105, the transition determination unit 105 determines whether to accept or reject the state update according to the calculated transition probability. For example, when the transition probability value is set to X, the transition determination unit 105 uses a random number r (0≤r≤1) generated by a random number generator (not shown) to determine acceptance if X≥r, otherwise rejection. When the determination result is “rejection” the process returns to step S103.

$$p \left(Δ f , T\right) \text{=} exp \left(- \frac{\text{Δ} f}{T}\right) \qquad \text{(9)}$$

In equation (9), Δf denotes a difference between evaluation functions when the state update is performed. T denotes temperature.

When the determination result in step S105 is “acceptance,” then in step S106, the state update unit 106 updates the state of the variable in the state memory 108. The state update unit 106 stores the updated variable in the update memory 107.

Once the processing of steps S103 to S106 are performed for L variables, the process moves to step S108 (step S107). When the number of executions is less than L, return to step S103.

The information processing device 100 terminates the process when the termination condition is satisfied (step S108). When the termination condition is not satisfied, the process returns to step S101. The termination condition is, for example, that the process of step S101 has been executed a predetermined number of times or that the value of the evaluation function has fallen below a predetermined threshold value. However, those are examples, and other conditions may be used.

The temperature controller 109 determines a value of temperature in the transition probability when the transition decision unit 105 determines whether to accept or reject a state update in the process of step S105. The temperature controller 109 controls the value of temperature by setting a value of temperature as a constant value, decreasing a value of temperature each time a state update is performed, or multiplying a value of temperature by a constant each time a state update is performed, for example.

Next, the effect of this example embodiment is described.

In general, a difference calculation and state updating are performed sequentially, whereas in this example embodiment, the differences between the evaluation functions associated with the state transitions of multiple variables are simultaneously (in parallel) calculated in the process of step S102. The differences calculated in such a manner accumulate errors with the differences when the difference calculations are performed sequentially for each progress of state updates. In this example embodiment, by correcting the difference in the process of step S103, the dynamical system of the state update is made to match that of the case where the difference calculation is performed sequentially. The amount of calculation required to correct the differences is small compared to the amount of calculation in the case where the difference calculation is performed sequentially. Therefore, the efficiency by parallelization is high. In addition, the dynamical system of state transition in this example embodiment is the same as in the case of the sequential update. That is, the information processing device in this example embodiment can perform the same calculations in parallel as in the case of sequential difference calculations without violating the balance condition.

In other words, the Markov Chain Monte Carlo method in this example embodiment operates in parallel with high efficiency while ensuring convergence of the dynamical system. This is because it can be parallelized with high efficiency while using the same state transition rules as those of the sequential update in the case of the general Markov Chain Monte Carlo method. In addition, the information processing device of this example embodiment performs a state transition similar to it of sequential update, without changing the dynamical system with parallelization. Therefore, the effect of parallelization is increased. Further, since the information processing device of this example embodiment reuses the results of the difference calculations after modifying, it also solves the problem of not being able to achieve the high parallelization efficiency that the technique described in non-patent literature 2 encompasses.

### Example Embodiment 2

Hereinafter, the second example embodiment (example embodiment 2) is described with reference to the drawings.

### Description of Configuration

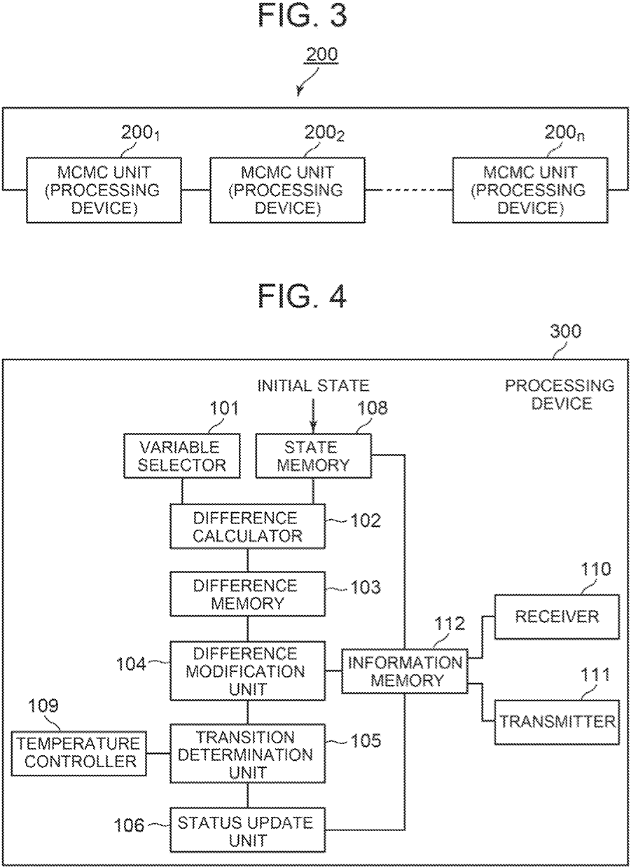

FIG. 3 is a block diagram showing an example configuration of the information processing device of the second example embodiment. The information processing device 200 of the second example embodiment consists of multiple MCMC units 200₁ to 200ₙ which are connected in a cyclic manner. Adjacent MCMC units are communicatively connected by a wired or wireless communication path. Each of the MCMC units 200₁ to 200ₙ is also referred to as a processing unit 300.

FIG. 4 is a block diagram showing a configuration example of the processing device 300, i.e., each MCMC unit 200₁ - 200ₙ. Compared to the information processing unit 100 of the first example embodiment, the processing unit 300 has an information memory 112 instead of the update memory 107. In addition, a receiver 110 and a transmitter 111 are added. Although not shown in FIG. 4, the difference calculator 102 includes L calculators 102₁ to 102_{L} that can operate in parallel.

Each of multiple MCMC units 200₁ - 200ₙ is assigned multiple variables for which the unit is responsible for updating. The variable selector 101 in each of the MCMC units 200₁ -200ₙ selects a variable to be updated from the assigned multiple variables. Regarding multiple MCMC units 200₁ - 200ₙ, when N is the number of variables, (N+n-1)(i-1)/ n-th to (N+n-1)i/n-th variables are assigned to the i-th MCMC units (for example, MCMC unit 200₁), and (N+n-1)(n-1)/n-th to N-th variables are assigned to the n-th MCMC units (for example, MCMC unit 200ₙ).

In each of the MCMC unit 200₁ - 200ₙ, the variable selection unit 101 selects L variables to be updated from the multiple variables assigned as described above. By appropriately defining the number L, the calculation speed can be expected to improve. For example, L is optimized in a binary search based on the calculation time when the difference calculation is actually executed. The difference calculator 102 calculates, for each of the variables selected by the variable selector 101, a difference between evaluation functions when changing the state. The difference calculator 102 stores the differences between the evaluation functions in the difference memory 103.

The difference modification unit 104 calculates modification of difference based on values of differences stored in the difference memory 103 and a set of variables updated by the other MCMC units, that is stored in the information memory 112. The operations of the transition determination unit 105, the state update unit 106, and the temperature controller 109 are the same as those in the first example embodiment. The state memory 108 stores the current states of the all variables.

The receiver 110 receives information transmitted from the transmitter 111 in the other MCMC unit and stores it in the information memory 112. The transmitter 111 transmits contents in the information memory 112 to the receiver 110 in the other MCMC unit.

The information memory 112 stores the transitioned variables for transmitting to the other MCMC unit. In addition, the information memory 112 stores variables received from the other MCMC unit. The variables received from the other MCMC unit are used in the calculation of the difference modification unit 104.

### Description of Operation

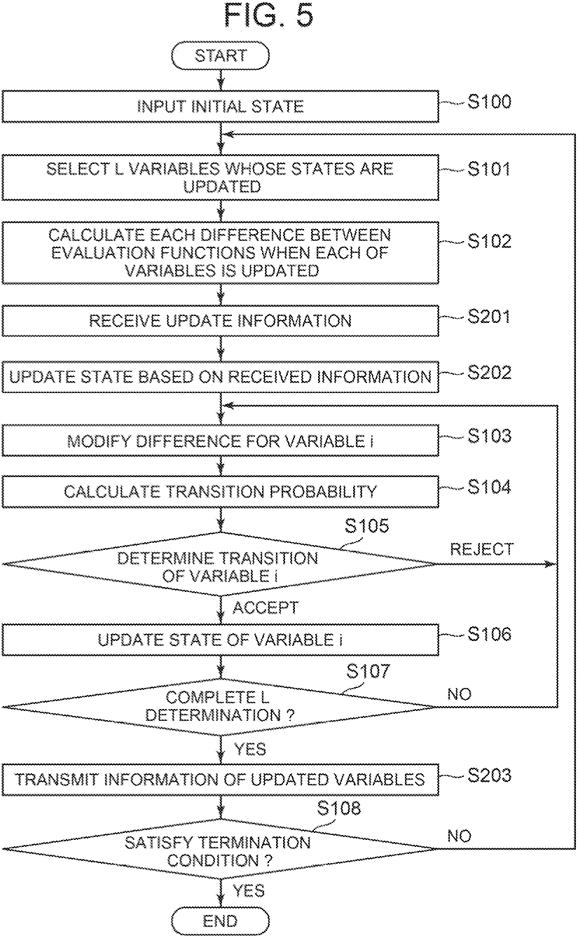

Next, the operation of this example embodiment is explained with reference to the flowchart of FIG. 5.

Once the initial state is determined, the initial state is stored in the state memory 108 (step S100). The initial state is selected randomly.

In this example embodiment, the number of iterations is M, and the following processing of steps S101 to S106 and steps S201 to S203 is repeated M times. The processes of steps S101 to S107 are the same as the processes in the first example embodiment.

First, in step S101, the variable selector 101 selects L variables whose states are updated. Next, in step S102, the difference calculator 102 (specifically, each of L calculators) calculates a difference between evaluation functions when updating the state for each of the variables selected in the process of step S101, and stores the calculation results in the difference memory 103. The evaluation function is expressed, for example, as in equation (6) above. The difference between evaluation functions is expressed by equation (7) above.

In step S201, the receiver 110 stores in the information memory 112 a set of variables whose states have been updated that are transmitted from the transmitter 111 in the other MCMC unit. In step S202, the state update unit 106 rewrites the variables in the state memory 108 according to the set of updated variables stored in the information memory 112.

Next as in the first example embodiment, the processing of steps S103 to S106 is executed in turn for each of L variables (defined as variable i) selected in the process of step S101. As described above, although the processing of steps S103 to S106 is different from the processing of the primitive MCMC described in the background art, it reproduces the same dynamical system.

In step S103, the difference modification unit 104 calculates modification of difference (refer to equation (8)) for variable i, based on the value of the difference between evaluation functions of variable i stored in the difference memory 103 and the set of updated variables j stored in the information memory 112. This modification restores the value of the difference to that used in the primitive dynamical system by the non-parallel process, and the dynamical system of the state update is consistent with the difference by the primitive Markov Chain Monte Carlo method.

Next, in step S104, the transition determination unit 105 calculates the transition probability (refer to equation (9) above) according to the difference calculated by the difference modification unit 104 and the value of temperature controlled by the temperature controller 109. In step S105, the transition determination unit 105 determines whether to accept or reject the state update according to the calculated probability. For example, when the transition probability value is set to X, the transition determination unit 105 uses a random number r (0≤ r≤1) generated by a random number generator (not shown) to determine acceptance if X≥r, otherwise rejection. When the determination result is “rejection” the process returns to step S103.

When the determination result in step S105 is “acceptance,” then in step S106, the state update unit 106 updates the state of the variable in the state memory 108. The state update unit 106 stores the updated variable in the information memory 112.

Once steps S103 to S106 are executed for L variables, the process moves to step S108 (step S107). When the number of executions is less than L, return to step S103.

As in the first example embodiment, the temperature controller 109 determines the value of temperature in the transition probability when the transition decision unit 105 determines whether to accept or reject the state update in the process of step S105. As in the case of the first example embodiment, the temperature controller 109 controls the value of temperature by setting a value of temperature as a constant value, decreasing a value of temperature each time a state update is performed, or multiplying a value of temperature by a constant each time a state update is performed, for example.

Next, in step S203, the transmitter 111 transmits variables whose states have been updated, which is stored in the information memory 112, to the receiver 110 in the connected MCMC unit.

The information processing device 100 terminates the processing when the termination condition is satisfied (step S108). When the termination condition is not satisfied, the process returns to step S101. The termination condition is the same as the condition in the first example embodiment.

Next, the effect of this example embodiment is described.

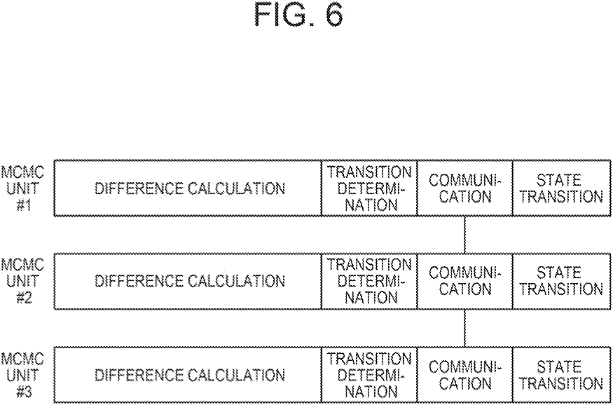

FIG. 6 is an explanatory diagram showing a calculation flow of MCMC by a primitive (general) information processing device. FIG. 6 illustrates a case in which the dynamical system is parallelized by primitive parallelization in three processes (corresponding to MCMC units #1 to #3 in FIG. 6) in the information processing device. In the primitive information processing device, all processes cooperate to advance multiple difference calculations through communication in a reduction process in which all processes participate.

It should be noted that when the method described in non-patent literature 2 is used, the result is rejected in case a state transition occurs.

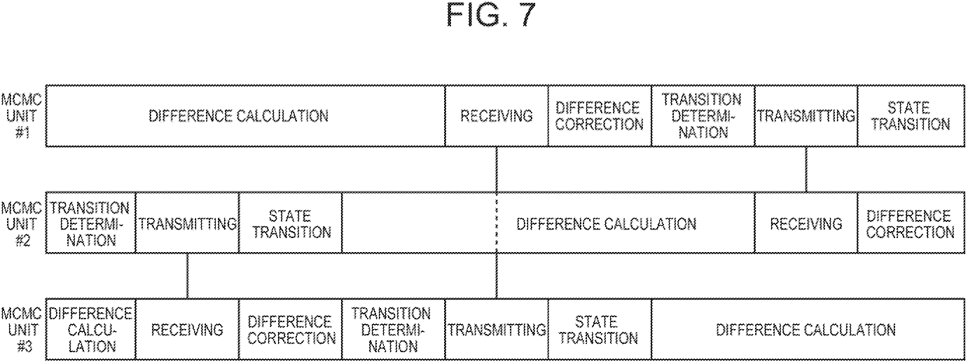

FIG. 7 is an explanatory diagram showing a calculation flow of MCMC by the information processing device of the second example embodiment. FIG. 7 illustrates a case in which the dynamical system is parallelized in three processes (corresponding to MCMC units #1 to #3 in FIG. 7) in the information processing device of the second example embodiment. In the second example embodiment, the communication is executed in a one-to-one communication between MCMC units. The process of step S102 (difference calculation process) in one MCMC unit can be executed in parallel with the process of step S201 (receiving process) or step S203 (transmission process) in other MCMC units. In other words, one process (MCMC unit) can execute the difference calculation process of step S102 when the other process (MCMC unit) performs a communication. As a result, communication latency is hidden.

In the second example embodiment, the amount of calculation increases by the amount of processing to modify differences (process in step S103), but the incremental amount of calculation is smaller than the amount of calculation for difference calculation. Therefore, the efficiency of parallelization of the information processing system of the second example embodiment is higher than the efficiency of parallelization of the primitive information processing system. Although the structure of the difference calculator 102 is parallelized (pipelined) in the methods of the first and second example embodiments, the whole state transition itself is equivalent to the state transition in the sequentially executed Markov Chain Monte Carlo method.

The first and second example embodiments are suitably applied to the solution of the combinatorial optimization problem, but can also be applied to a simulation of a magnetic material and the like. Although in the first and second example embodiments, the Ising model is used and the source (state) of a certain space (set) is sampled by the Markov Chain Monte Carlo method, the first and second example embodiments can be applied to other methods that use a state transition.

Each component in each of the above example embodiments may be configured with a piece of hardware or a piece of software. Alternatively, the components may be configured with a plurality of pieces of hardware or a plurality of pieces of software. Further, a part of the components may be configured with hardware and the other part with software.

The functions (processes) in the above example embodiments may be realized by a computer having a processor such as a central processing unit (CPU), a memory, etc. For example, a program for performing the method (processing) in the above example embodiments may be stored in a storage device (storage medium), and the functions may be realized with the CPU executing the program stored in the storage device.

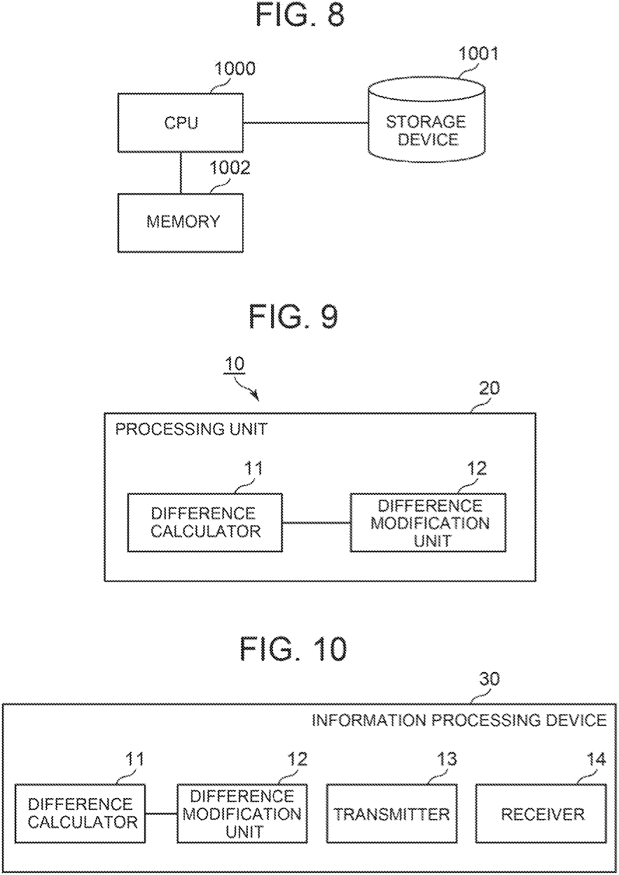

FIG. 8 is a block diagram showing an example of a computer with a CPU. The computer is implemented in the information processing device. A CPU 1000 executes processing in accordance with a program stored in a storage device 1001 to realize the functions in the above example embodiments. That is to say, the functions of the variable selector 101, the difference calculator 102, the difference modification unit 104, the transition determination unit 105, the state update unit 106, and the temperature controller 109 in the information processing device 100 shown in FIG. 1 are realized.

In addition, the CPU 1000 executes processing in accordance with a program stored in the storage device 1001 to realize the functions of the variable selector 101, the difference calculator 102, the difference modification unit 104, the transition determination unit 105, the state update unit 106, the temperature controller 109, the receiver 110 (excluding the hardware portion for communication), and the transmitter 111 (excluding the hardware portion for communication) in the processing device 300 shown in FIG. 4 are realized.

The difference memory 103, the update memory 107, the state memory 108, and the information memory 112 can be realized by the storage device 1001 or a memory 1002.

The storage device 1001 is, for example, a non-transitory computer readable media. The non-transitory computer readable medium is one of various types of tangible storage media. Specific examples of the non-transitory computer readable media include a magnetic storage medium (for example, hard disk), a magneto-optical storage medium (for example, magneto-optical disc), a compact disc-read only memory (CD-ROM), a compact disc-recordable (CD-R), a compact disc-rewritable (CD-R/W), and a semiconductor memory (for example, a mask ROM, a programmable ROM (PROM), an erasable PROM (EPROM), a flash ROM).

The program may be stored in various types of transitory computer readable media. The transitory computer readable medium is supplied with the program through, for example, a wired or wireless communication channel, or, through electric signals, optical signals, or electromagnetic waves.

The memory 1002 is a storage means implemented by a RAM (Random Access Memory), for example, and temporarily stores data when the CPU 1000 executes processing. It can be assumed that a program held in the storage device 1001 or a temporary computer readable medium is transferred to the memory 1002 and the CPU 1000 executes processing based on the program in the memory 1002.

FIG. 9 is a block diagram showing the main part of an information processing device. The information processing device 10 shown in FIG. 9 comprises a processing unit 20 including a difference calculator 11 (in the example embodiments, realized by the difference calculator 102) which calculate differences between evaluation functions in parallel when changing a state of each of variables selected from a plurality of variables, and a difference modification unit 12 (in the example embodiments, realized by the difference calculator 102) which modifies the difference calculated by the difference calculator 11 so as to cancel an error between a sequentially calculated difference.

FIG. 10 is a block diagram showing the main part of another type of the information processing device. The information processing device 30 shown in FIG. 10 includes a difference calculator 11 which calculate differences between evaluation functions in parallel when changing a state of each of variables selected from a plurality of variables, a difference modification unit 12 which modifies the difference calculated by the difference calculator 11 so as to cancel an error between a sequentially calculated difference, a transmitter 13 (in the example embodiments, realized by the transmitter 111) which transmits the variable whose state has been updated to other information processing device, and a receiver 14 (in the example embodiments, realized by the receiver 110) which receives the variable whose state has been updated from other information processing device, and wherein the difference modification unit 12 modifies the difference using a set of the variables, which are received from other information processing device, whose state have been updated.

Although the invention of the present application has been described above with reference to example embodiments, the present invention is not limited to the above example embodiments. Various changes can be made to the configuration and details of the present invention that can be understood by those skilled in the art within the scope of the present invention.

REFERENCE SIGNS LIST

| | |
|---|---|
| 10, 30 | Information processing device |
| 11 | Difference calculator |
| 12 | Difference modification unit |
| 13 | Transmitter |
| 14 | Receiver |
| 20 | Processing Unit |
| 100 | Information processing device |
| 101 | Variable selector |
| 102 | Difference calculator |
| 102₁ ~102_{L} | Calculator |
| 103 | Differential memory |
| 104 | Difference modification unit |
| 105 | Transition determination unit |
| 106 | Status update unit |
| 107 | Update memory |
| 108 | State memory |
| 109 | Temperature controller |
| 110 | Receiver |
| 111 | Transmitter |
| 112 | Information memory |
| 200 | Information processing device |
| 200₁ ~200ₙ | MCMC unit |
| 300 | Processing device |

What is claimed is:

1. An information processing device comprising:
a memory storing software instructions, and
one or more processors configured to execute the software instructions to
calculate differences between evaluation functions in parallel when changing a state of each of variables selected from a plurality of variables; and
modify the calculated difference so as to cancel an error between a sequentially calculated difference.

2. The information processing device according to claim 1, wherein
the one or more processors is configured to further execute the software instructions to
control temperature as a control parameter, and
calculate a transition probability based on the temperature and the modified difference, and update the state of variable according a calculation result.

3. The information processing device according to claim 2, wherein
the one or more processors is configured to further execute the software instructions to
calculate the difference between evaluation functions regarding a variable of an Ising model, and
update the state of variable based on a Markov Chain Monte Carlo method.

4. The information processing device comprising multiple processors according to claim 1, wherein
each processor is configured to further execute the software instructions to
transmit the variable whose state has been updated to other processor,
receive the variable whose state has been updated from other processor, and
modify the difference using a set of the variables, which are received from other processor, whose state have been updated.

5. The information processing device according to claim 4, wherein
the processor is configured to further execute the software instructions to perform calculation on a pre-assigned number of variables from a plurality of variables.

6. An information processing method, implemented by a processor, comprising:
calculating differences between evaluation functions in parallel when changing a state of each of variables selected from a plurality of variables; and
modifying the calculated difference so as to cancel an error between a sequentially calculated difference.

7. The information processing method, implemented by a processor, according to claim 6, further comprising
calculating a transition probability based on temperature as a control parameter and the modified difference, and updating the state of variable according a calculation result.

8. The information processing method, implemented by a processor, according to claim 7, further comprising
calculating the difference between evaluation functions regarding a variable of an Ising model, and
updating the state of variable based on a Markov Chain Monte Carlo method.

9. A non-transitory computer readable recording medium storing an information processing program causing a computer to execute:
calculating differences between evaluation functions in parallel when changing a state of each of variables selected from a plurality of variables; and
modifying the calculated difference so as to cancel an error between a sequentially calculated difference.

10. The computer readable recording medium according to claim 9, causing a computer to further execute:
calculating a transition probability based on temperature as a control parameter and the modified difference, and
updating the state of variable according a calculation result.
